(19) United States
(12) Patent Application Publication
(10) Pub. No.: US 2023/0217440 A1
(43) Pub. Date: Jul. 6, 2023

(54) DOWNLINK CONTROL INFORMATION ALLOCATION REDUCTION FOR MASSIVE MULTIPLE-INPUT MULTIPLE-OUTPUT BASED NETWORKS

(71) Applicant: QUALCOMM Incorporated, San Diego, CA (US)

(72) Inventors: Lior UZIEL, Hod Hasharon (IL); Guy WOLF, Rosh Haayin (IL); Shay LANDIS, Hod Hasharon (IL)

(21) Appl. No.: 17/646,951

(22) Filed: Jan. 4, 2022

(51) Int. Cl. H04W 72/12

(52) U.S. Cl. CPC H04W 72/1278

(57) ABSTRACT

Various aspects of the present disclosure generally relate to wireless communication. In some aspects, a user equipment (UE) may receive a first portion of downlink control information (DCI), via one or more control channel element resources, that includes information associated with a second portion of the DCI in a physical shared channel. The UE may obtain the second portion of the DCI via the physical shared channel based at least in part on the information. Numerous other aspects are described.

### FIELD OF THE DISCLOSURE

Aspects of the present disclosure generally relate to wireless communication and to techniques and apparatuses for downlink control information allocation reduction for massive multiple-input multiple output based networks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example resource structure for wireless communications, in accordance with the present disclosure.

FIG. 4 is a diagram illustrating an example of physical downlink control channel mapping, in accordance with the present disclosure.

FIG. 5 is a diagram illustrating an example associated with downlink control information (DCI) allocation reduction for massive multiple-input multiple output (MIMO) based networks, in accordance with the present disclosure.

FIG. 6 is a diagram illustrating an example associated with comparing example options for reducing DCI allocation, in accordance with the present disclosure.

FIG. 7 is a diagram illustrating an example process, performed by the UE, associated with DCI allocation reduction for massive MIMO based networks, in accordance with the present disclosure.

FIG. 8 is a diagram illustrating an example process, performed by the base station, associated with DCI allocation reduction for massive MIMO based networks, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### SUMMARY

Some aspects described herein relate to a method of wireless communication performed by a user equipment (UE). The method may include receiving a first portion of downlink control information (DCI), via one or more control channel element resources, that includes information associated with a second portion of the DCI in a physical shared channel. The method may include obtaining the second portion of the DCI via the physical shared channel based at least in part on the information.

Some aspects described herein relate to a method of wireless communication performed by a base station. The method may include transmitting a first portion of DCI, via one or more control channel element resources, that includes information associated with a second portion of the DCI in a physical shared channel. The method may include transmitting the second portion of the DCI via the physical shared channel.

Some aspects described herein relate to an apparatus for wireless communication performed by a UE. The apparatus may include a memory and one or more processors, coupled to the memory. The one or more processors may be configured to receive a first portion of DCI, via one or more control channel element resources, that includes information associated with a second portion of the DCI in a physical shared channel. The one or more processors may be configured to obtain the second portion of the DCI via the physical shared channel based at least in part on the information.

Some aspects described herein relate to an apparatus for wireless communication performed by a base station. The apparatus may include a memory and one or more processors, coupled to the memory. The one or more processors may be configured to transmit a first portion of DCI, via one or more control channel element resources, that includes information associated with a second portion of the DCI in a physical shared channel. The one or more processors may be configured to transmit the second portion of the DCI via the physical shared channel.

Some aspects described herein relate to a non-transitory computer-readable medium that stores a set of instructions for wireless communication by a UE. The set of instructions, when executed by one or more processors of the UE, may cause the UE to receive a first portion of DCI, via one or more control channel element resources, that includes information associated with a second portion of the DCI in a physical shared channel. The set of instructions, when executed by one or more processors of the UE, may cause the UE to obtain the second portion of the DCI via the physical shared channel based at least in part on the information.

Some aspects described herein relate to a non-transitory computer-readable medium that stores a set of instructions for wireless communication by a base station. The set of instructions, when executed by one or more processors of the base station, may cause the base station to transmit a first portion of DCI, via one or more control channel element resources, that includes information associated with a second portion of the DCI in a physical shared channel. The set of instructions, when executed by one or more processors of the base station, may cause the base station to transmit the second portion of the DCI via the physical shared channel.

Some aspects described herein relate to an apparatus for wireless communication. The apparatus may include means for receiving a first portion of DCI, via one or more control channel element resources, that includes information associated with a second portion of the DCI in a physical shared channel. The apparatus may include means for obtaining the second portion of the DCI via the physical shared channel based at least in part on the information.

Some aspects described herein relate to an apparatus for wireless communication. The apparatus may include means for transmitting a first portion of DCI, via one or more control channel element resources, that includes information associated with a second portion of the DCI in a physical shared channel. The apparatus may include means for transmitting the second portion of the DCI via the physical shared channel.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

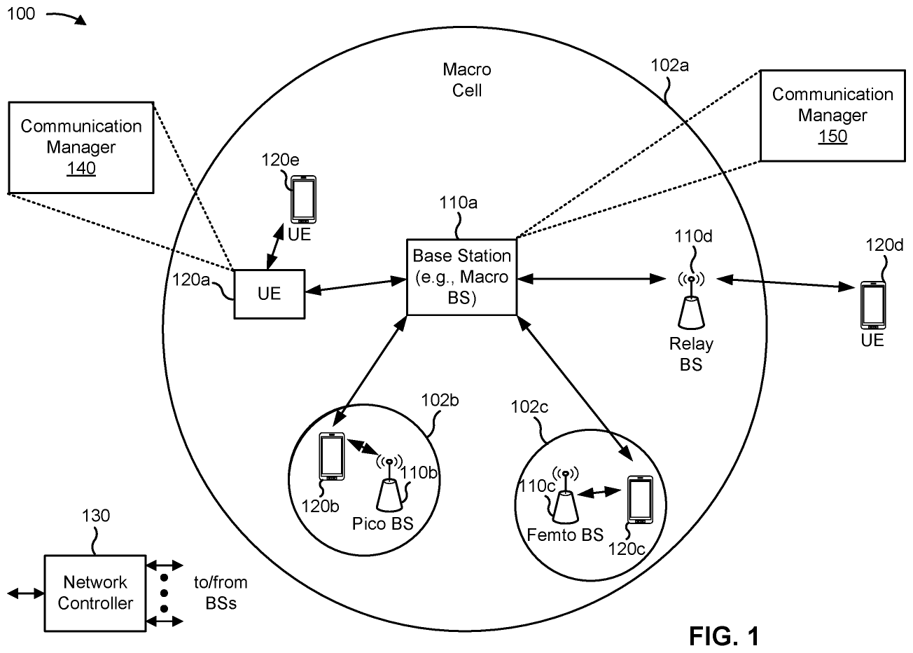

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support an RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first portion of downlink control information (DCI), via one or more control channel element resources, that includes information associated with a second portion of the DCI in a physical shared channel; and obtain the second portion of the DCI via the physical shared channel based at least in part on the information. Additionally, or alternatively, the communication manager 140 may perform one or more other operations described herein.

In some aspects, the base station 110 may include a communication manager 150. As described in more detail elsewhere herein, the communication manager 150 may transmit a first portion of DCI, via one or more control channel element resources, that includes information associated with a second portion of the DCI in a physical shared channel; and transmit the second portion of the DCI via the physical shared channel. Additionally, or alternatively, the communication manager 150 may perform one or more other operations described herein.

As indicated above, FIG. 1 is provided as an example. Other examples may differ from what is described with regard to FIG. 1.

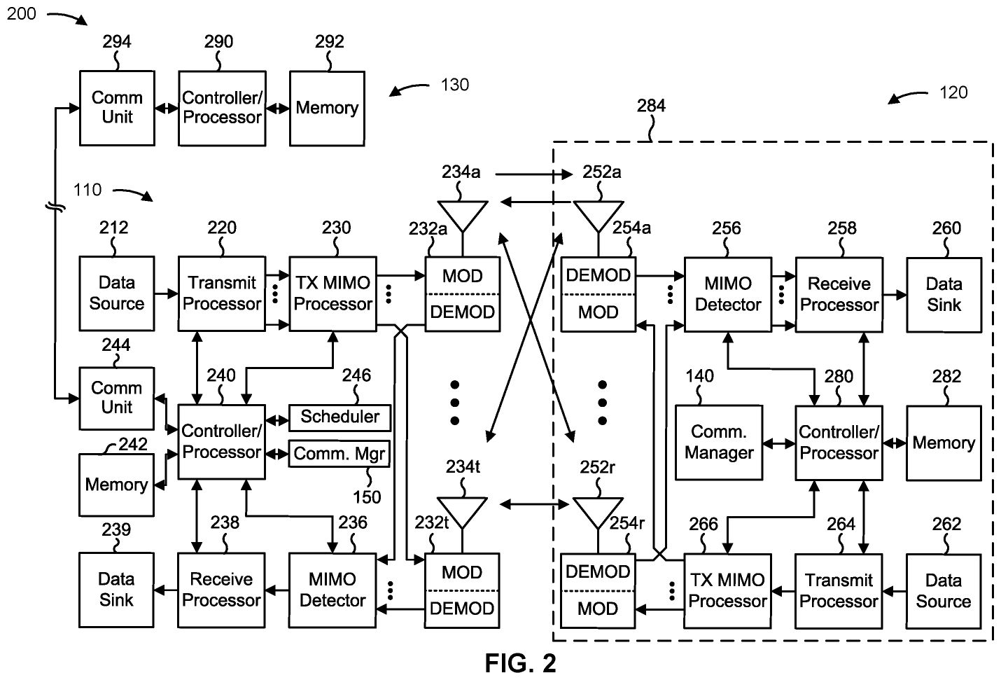

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

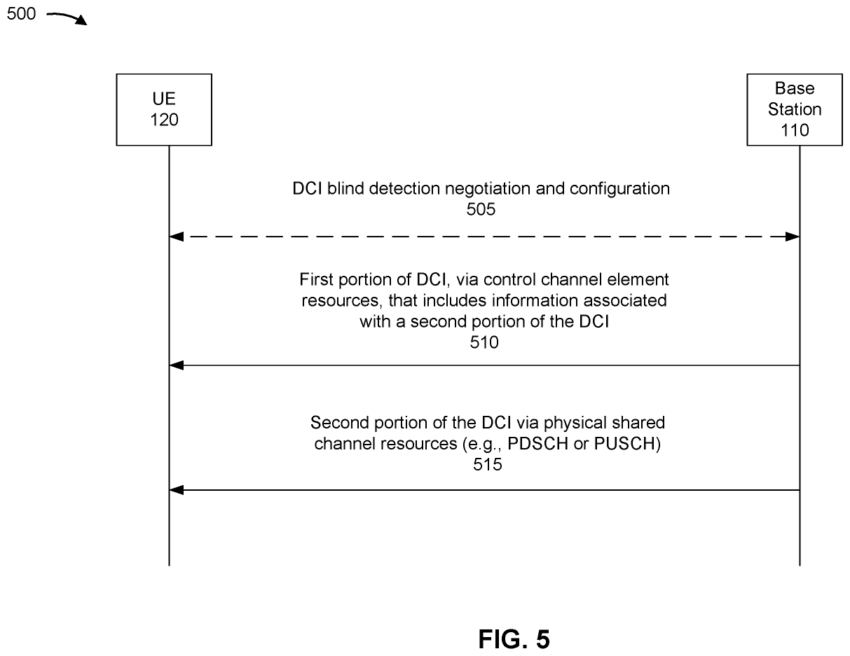

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

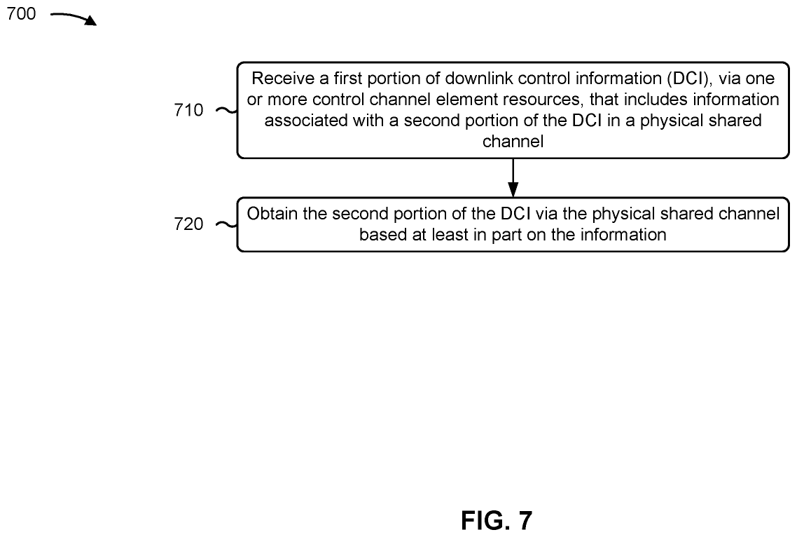

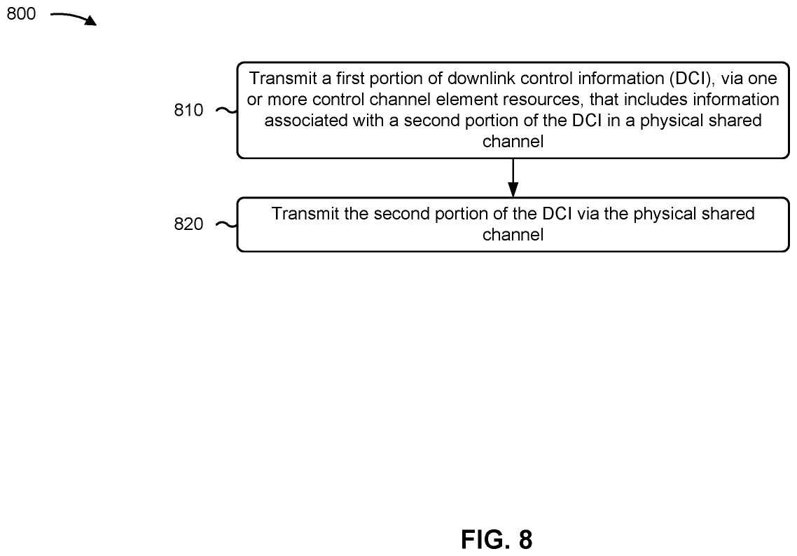

The controller/processor 240 of the base station 110, the controller/processor 280 of the UE 120, and/or any other component(s) of FIG. 2 may perform one or more techniques associated with DCI allocation reduction for massive MIMO based networks, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for receiving a first portion of DCI, via one or more control channel element resources, that includes information associated with a second portion of the DCI in a physical shared channel; and/or means for obtaining the second portion of the DCI via the physical shared channel based at least in part on the information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting a first portion of DCI, via one or more control channel element resources, that includes information associated with a second portion of the DCI in a physical shared channel; and/or means for transmitting the second portion of the DCI via the physical shared channel. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

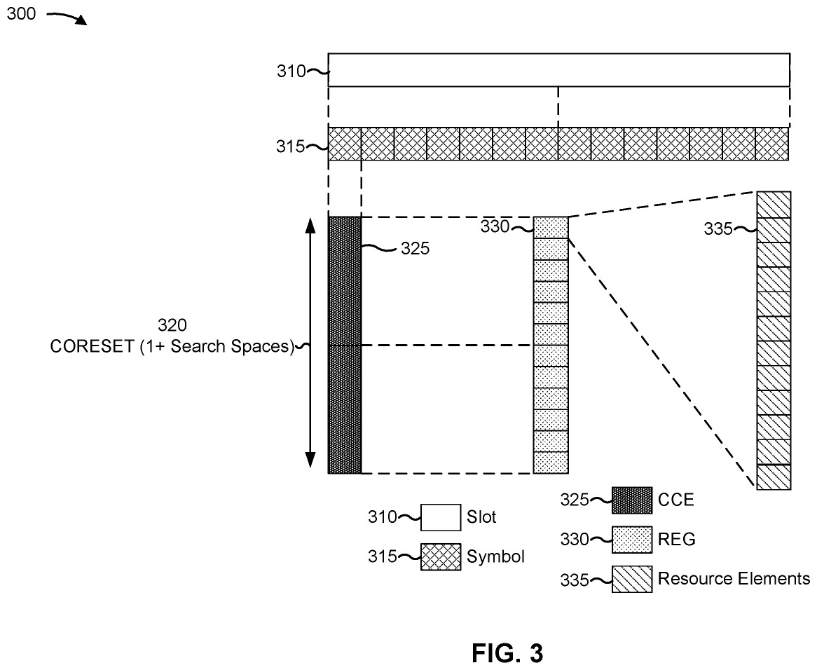

FIG. 3 is a diagram illustrating an example resource structure 300 for wireless communication, in accordance with the present disclosure. Resource structure 300 shows an example of various groups of resources described herein. As shown, resource structure 300 may include a slot 310. In some cases, the slot 310 may include multiple symbols 315. For example, the slot 310 may include 14 symbols, or 7 symbols, among other examples.

The potential control region of a slot 310 may be referred to as a control resource set (CORESET) 320 and may be structured to support an efficient use of resources, such as by flexible configuration or reconfiguration of resources of the CORESET 320 for one or more physical downlink control channels (PDCCHs) and/or one or more physical downlink shared channels (PDSCHs). In some cases, the CORESET 320 may occupy the first symbol 315 of a slot 310, the first two symbols 315 of a slot 310, or the first three symbols 315 of a slot 310. Thus, a CORESET 320 may include multiple resource blocks (RBs) in the frequency domain, and either one, two, or three symbols 315 in the time domain In 5G, a quantity of resources included in the CORESET 320 may be flexibly configured, such as by using radio resource control (RRC) signaling to indicate a frequency domain region (e.g., a quantity of resource blocks) and/or a time domain region (e.g., a quantity of symbols) for the CORESET 320.

As illustrated, a symbol 315 that includes CORESET 320 may include one or more control channel elements (CCEs) 325, shown as two CCEs 325 as an example, that span a portion of the system bandwidth. A CCE 325 may include DCI that is used to provide control information for wireless communication. A base station may transmit DCI during multiple CCEs 325 (as shown), where the quantity of CCEs 325 used for transmission of DCI represents the aggregation level (AL) used by the BS for the transmission of DCI. In FIG. 3, an aggregation level of two is shown as an example, corresponding to two CCEs 325 in a slot 310. In some cases, different aggregation levels may be used, such as 1, 2, 4, 8, 16, or another aggregation level.

Each CCE 325 may include a fixed quantity of resource element groups (REGs) 330, shown as 6 REGs 330, or may include a variable quantity of REGs 330. In some cases, the quantity of REGs 330 included in a CCE 325 may be specified by a REG bundle size. A REG 330 may include one resource block, which may include 12 resource elements (REs) 335 within a symbol 315. A resource element 335 may occupy one subcarrier in the frequency domain and one OFDM symbol in the time domain

A search space may include all possible locations (e.g., in time and/or frequency) where a PDCCH may be located. A CORESET 320 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a UE may be referred to as a UE-specific search space. Similarly, the set of all possible PDCCH locations across all UEs may be referred to as a common search space. The set of all possible PDCCH locations for a group of UEs may be referred to as a group-common search space. One or more search spaces across aggregation levels may be referred to as a search space (SS) set.

A CORESET 320 may be interleaved or non-interleaved. An interleaved CORESET 320 may have CCE-to-REG mapping such that adjacent CCEs are mapped to scattered REG bundles in the frequency domain (e g , adjacent CCEs are not mapped to consecutive REG bundles of the CORESET 320). A non-interleaved CORESET 320 may have a CCE-to-REG mapping such that all CCEs are mapped to consecutive REG bundles (e.g., in the frequency domain) of the CORESET 320.

In some cases, as described in more detail below, the resource allocation for DCI in massive MIMO communications may require a large percentage of the available resources (e.g., CORESET resources).

As indicated above, FIG. 3 is provided as an example. Other examples may differ from what is described with respect to FIG. 3.

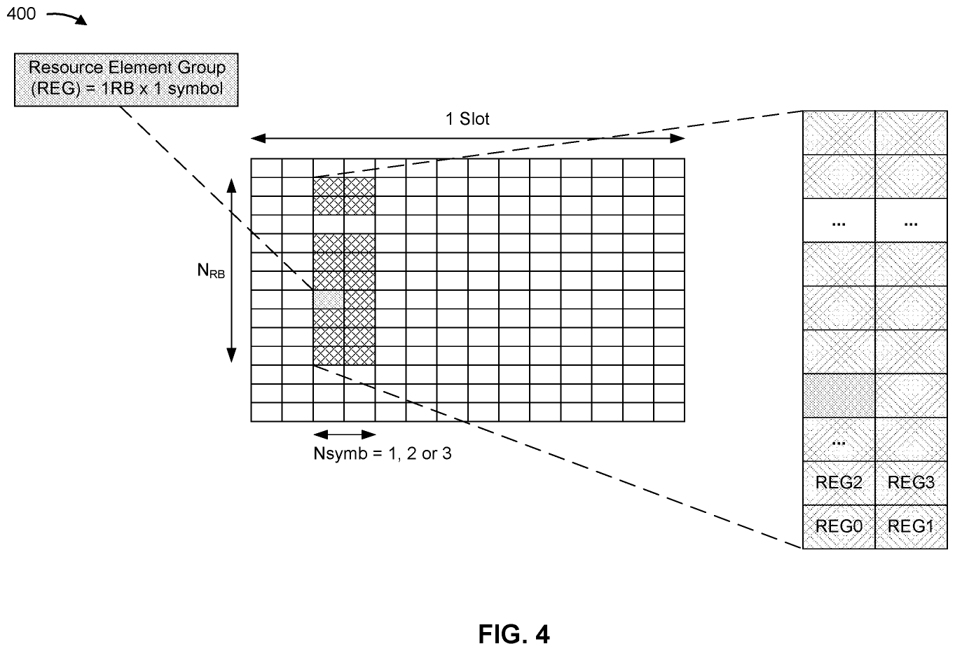

FIG. 4 is a diagram illustrating an example 400 of PDCCH mapping, in accordance with the present disclosure.

As described above, the PDCCH may be mapped to 1, 2, 4, 8, or 16 CCEs, based at least in part on the aggregation level, in order to increase the likelihood of reception by the UE 120. Each CCE may contain 6 REGs, and each REG (e.g., each physical resource block (PRB)) may include 12 REs within a symbol. In some cases, the PDCCH-DMRS may occupy one quarter of the REs (e.g., REs 1, 5, and 9). In some cases, the PDCCH may be modulated using quadrature phase shift keying (QPSK) (e.g., using a 2 bit constellation). Therefore, each CCE may include 108 coded bits (e.g., 6[REGs]×12[REs]×¾[non-DMRS]×2[QPSK]).

In some cases, the aggregation level may be based at least in part on the DCI payload and the channel conditions. For example, a larger aggregation level may be needed if the DCI payload is large and/or the channel conditions are poor. In some cases, an example aggregation level of 4 may be sufficient to compensate for the large DCI payload and the poor channel conditions. Thus, as shown in the example 400, the PDCCH may consume 4 CCEs.

In some cases, 273 PRBs may be available for a 100 MHz channel bandwidth using 30 KHz subcarrier spacing (SCS). The number of CCEs that are available may be based at least in part on the number of symbols in the CORESET (e.g., 1, 2, or 3) and the aggregation level (e.g., 1, 2, 4, 8, or 16). Using the example aggregation level of 4, the number of DCI resources may be 11, 22, or 34 when using 1, 2, or 3 symbols, respectively. In some cases, 3 of the 14 (˜21%), 2 of the 14 (˜14%), or 1 of the 14 (˜7%) downlink resources of a full downlink slot may be used for the DCI. Table 1 shows an example of the number of DCI resources required based at least in part on the AL and the number of symbols.

TABLE 1

| AL/symbols | 1 | 2 | 3 |
|---|---|---|---|
| 1 | 45 | 91 | 137 |
| 2 | 22 | 45 | 68 |
| 4 | 11 | 22 | 34 |
| 8 | 5 | 11 | 17 |
| 16 | 2 | 5 | 8 |

In some cases, for frequency division duplexing (FDD) or time division duplexing (TDD) with no uplink centric downlink-uplink ratio, the number of DCI resources required may be equal to the number of scheduled downlink UEs plus the number of scheduled uplink UEs. In some cases, for TDD with an uplink centric downlink-uplink ratio, the number of DCI resources required may be equal to the number of scheduled downlink UEs plus the number of scheduled uplink UEs, per uplink-downlink ratio. In some cases, these calculations may not include the number of broadcasts and other general control messages, such as DCI resources with non-cell radio network temporary identifiers (c-RNTIs), which may increase the number of DCI resources even further.

In some cases, base stations for massive MIMO communications may support at least 8 layers (in some cases, may support 16 layers), and may be required to support 64 downlink and 64 uplink scheduled UEs per slot for the 100 MHz channel bandwidth. In the FDD use case, the number of required DCI resources is 128, whereas the total number of available resources is 137 (with AL=1) and when using 3 out of the 14 (˜21%) symbols for the downlink resources. In the TDD example with multiple uplink transmissions per downlink transmission, the percentage of the total resources may be even greater. Thus, for massive MIMO communications, the resource allocation for DCI may require a large percentage of the total number of available resources (e.g., CORESET resources), or may be even greater than the total number of available resources.

Techniques and apparatuses are described herein for DCI allocation reduction for massive MIMO based networks. In some aspects, the DCI may be split into a first portion and a second portion. For example, the first portion of the DCI may be located (e.g., blind decoded) in one or more CORESET resources, and the second portion of the DCI may be transmitted and received via a physical shared channel. In some aspects, a UE may receive the first portion of the DCI, via one or more CCE resources, that includes information associated with the second portion of the DCI in the physical shared channel. The UE may obtain the second portion of the DCI from the physical shared channel based at least in part on the information. For example, the UE may receive the first portion of the DCI that includes the information, and the UE may decode the second portion of the DCI and/or the physical shared channel based at least in part on the information.

As described above, the resource allocation for DCI in massive MIMO networks may require a large percentage of the total number of available resources (e.g., control channel resources). Using the techniques and apparatuses described herein, the DCI may be communicated in one or more portions. A first portion of the DCI may be communicated via the control channel element resources (e.g., as regular DCI), and a second portion of the DCI may be communicated (e.g., with other data) via the physical shared channels. In some cases, reducing the size of the DCI (e.g., by lowering the number of payload bits, such by moving one or more fields to the second portion of the DCI) may enable the DCI to be located in a single CCE (with AL=1). Thus, the resource allocation (e.g., in the CORESET resources) for DCI in massive MIMO networks may be reduced.

As indicated above, FIG. 4 is provided as an example. Other examples may differ from what is described with respect to FIG. 4.

FIG. 5 is a diagram illustrating an example 500 of DCI allocation reduction for massive MIMO based networks, in accordance with the present disclosure. A UE, such as the UE 120, may communicate with a base station, such as the base station 110.

As shown in connection with reference number 505, the UE 120 and the base station 110 may negotiate (e.g., perform a negotiation procedure) to determine one or more characteristics for DCI blind detection. In some aspects, the negotiation procedure may be performed using RRC signaling between the UE 120 and the base station 110. In some aspects, the UE 120 may be configured with a first DCI blind detection size (e.g., to be used as the standard DCI blind detection size) and a second DCI blind detection size (e.g., to be used as the fallback DCI blind detection size). For example, the first DCI size for blind detection may be 0_1/1_1 and the second DCI size for blind detection may be 0_0/1_0.

In some aspects, the base station 110 may configure the UE 120 with one or more other DCI size options for performing blind decoding. For example, the base station 110 may configure a third DCI size, a fourth DCI size, and a fifth DCI size, for performing blind decoding, that correspond to the first example, second example, and third example described below. The UE 120 may be configured to perform DCI blind detection using any of the first, second, third, fourth, or fifth options as the standard DCI size or the fallback DCI size for performing blind decoding. As described herein, the UE 120 may be configured to perform blind detection using a standard blind detection size (e.g., using any of the first through fifth options) and a fallback blind detection size (e.g., using any other of the first through fifth options). Thus, the number of blind searches performed by the UE 120 may be equal to two, and may not need to be increased.

As shown in connection with reference number 510, the base station 110 may transmit, and the UE 120 may receive, a first portion of DCI that includes information associated with a second portion of the DCI. In some aspects, the first portion of the DCI may be transmitted and received via one or more CORESET resources, such as the one or more CCE resources (e.g., to reduce the number of CCEs such that all of the DCIs may be included in a scarce location). For example, the first portion of the DCI may be blind decoded in the one or more CCE resources. In some aspects, the base station 110 may split the DCI into the first portion of the DCI and the second portion of the DCI. For example, the base station 110 may split the DCI into the first portion and the second portion in order to reduce the number of resources required for the DCI allocation.

In a first example, the first portion of the DCI may include information for decoding the physical shared channel. For example, the information associated with the second portion of the DCI may include one or more fields that include information for decoding the PDSCH or the physical uplink shared channel (PUSCH). In some aspects, the information for decoding the physical shared channel may include resource allocation information, precoding information, rate matching information, MCS information, or hybrid automatic repeat request (HARQ) information, among other examples. The information for decoding the physical shared channel may be information for decoding a first transport block (TB1) of the physical shared channel. In some aspects, the information for decoding the physical shared channel may include beta offset information.

In a second example, the first portion of the DCI may include information for decoding the second portion of the DCI. For example, the information associated with the second portion of the DCI may include one or more fields that include information for decoding the second portion of the DCI that is allocated in the PDSCH or the PUSCH. In some aspects, the information for decoding the second portion of the DCI may include resource allocation information, or PRB offset information, among other examples. In some aspects, the information for decoding the second portion of the DCI may include beta offset information.

In a third example, the second portion of the DCI may be second stage DCI, and the first portion of the DCI may include information for decoding the second stage DCI. For example, the information associated with the second portion of the DCI may include one or more fields that include information for decoding the second stage DCI. In some aspects, the second stage DCI may be located in a dedicated PDSCH (e.g., a robust PDSCH). Thus, the first portion of the DCI may include one or more fields for decoding the second stage DCI in the dedicated PDSCH. In some aspects, the second stage DCI is not a blind detected control channel, and therefore may be less restrictive than the first stage DCI (e.g., such as by having fewer search space locations, lower periodicity, or a single layer, among other examples). Thus, the second stage DCI may enable more resources to be included, as compared to the first stage DCI. In some aspects, the information for decoding the second stage DCI may include resource allocation information, precoding information, rate matching information, or HARQ feedback information, among other examples.

As shown in connection with reference number 515, the base station 110 may transmit, and the UE 120 may receive, the second portion of the DCI via one or more physical shared channel resources. For example, the second portion of the DCI may be communicated using one or more resources of the scheduled PDSCH and/or one or more resources of the scheduled PUSCH.

In the first example described above, the second portion of the DCI may be an integral part of the physical shared channel. For example, the second portion of the DCI may be included with other data being communicated in the PDSCH or the PUSCH. In some aspects, the second portion of the DCI may be part of the scheduled PDSCH, or the scheduled PUSCH, and may have the same robustness. In some aspects, the second portion of the DCI may include information that is not included in the first portion of the DCI. For example, the second portion of the DCI may include location information (e.g., for a second transport block (TB2)), or feedback information (e.g., channel state information (CSI)), among other examples. In some aspects, the second portion of the DCI may be located in a first physical resource block of the physical shared channel.

In the second example described above, the second portion of the DCI may be in a unique part of the physical shared channel. For example, the second portion of the DCI may be inserted into a location of the physical shared channel that is allocated specifically for the second portion of the DCI. In some aspects, the second portion of the DCI may include information associated with the physical shared channel. For example, the second portion of the DCI may include one or more fields for decoding the physical shared channel. In some aspects, the information (e.g., the one or more fields) may include precoding information, rate matching information, MCS information, or HARQ information, among other examples. In some aspects, the second portion of the DCI may be allocated in a PRB offset (e.g., to improve reception). For example, the second portion of the DCI may be allocated close to the DMRS symbols of the physical shared channel, any may not be rate matched. In some aspects, the second portion of the DCI may be QPSK modulated. In some aspects, the second portion of the DCI may be scrambled separately from the rest of the physical shared channel. In some aspects, the second portion of the DCI may be duplicated over multiple layers (e.g., non-precoded).

In some aspects, including the second portion of the DCI in the unique part of the physical shared channel may cause puncturing. In the case of rate matching (RM), the second portion of the DCI may be punctured as not indicated in the first portion of the DCI. For example, an RM indicator, or a CSI reference signal (RS) indicator (e.g., a zero power CSI-RS trigger), may not be included in the second portion of the DCI. In some aspects, the second portion of the DCI may not support HARQ feedback. For example, a new data indicator (NDI), redundancy version (RV) indicator, HARQ process indicator, or downlink assignment index (DAI), among other examples, may be missing from the second portion of the DCI.

In the third example described above, the second portion of the DCI may be second stage DCI. The second stage DCI may be located in a dedicated PDSCH. For example, the second stage DCI may be inserted in a dedicated PDSCH. The dedicated PDSCH may be separate from the other physical shared channel. For example, the UE 120 may receive the first portion of the DCI via the CCE resources, may receive the second portion of the DCI (e.g., the second stage DCI) via the dedicated PDSCH, and may use the second stage DCI for decoding the physical shared channel. In some aspects, the second stage DCI may include information (e.g., one or more fields) for decoding the physical shared channel. In some aspects, the information for decoding the physical shared channel may include resource allocation information, precoding information, rate matching information, MCS information, HARQ information, or beta offset information, among other examples. In some aspects, the second stage DCI may be allocated in a robust PDSCH that is QPSK modulated with rank 1.

As described above, the resource allocation for DCI in massive MIMO networks may require a large percentage of the total number of available resources (e.g., control channel resources). Using the techniques and apparatuses described herein, the DCI may be communicated in a first portion and a second portion. In the first example, the first portion of the DCI includes information for decoding the physical shared channel. In this example, the UE 120 may obtain a communication over the physical shared channel that includes the second portion of the DCI, and may decode the physical shared channel, including the second portion of the DCI, based at least in part on the information. In the second example, the second portion of the DCI is inserted in a unique location of the physical shared channel, and the first portion of the DCI includes first information for decoding the second portion of the DCI. In this example, the UE 120 may obtain a communication over the physical shared channel, decode the second portion of the DCI (using the first information) from the unique location to obtain second information, and decode the physical channel based at least in part on the second information. In the third example, the second portion of the DCI is second stage DCI that is received via a dedicated PDSCH, and the first portion of the DCI includes first information for decoding the second stage DCI. In this example, the UE 120 may obtain a first communication over the dedicated PDSCH, decode the second stage DCI (using the first information) from the dedicated PDSCH to obtain second information, obtain a second communication over a separate physical shared channel, and decode the physical shared channel using the second stage DCI. The resource allocation (e.g., in the CORESET resources) for DCI in massive MIMO networks may be reduced using one or more of the first example, the second example, or the third example described above.

As indicated above, FIG. 5 is provided as an example. Other examples may differ from what is described with respect to FIG. 5.

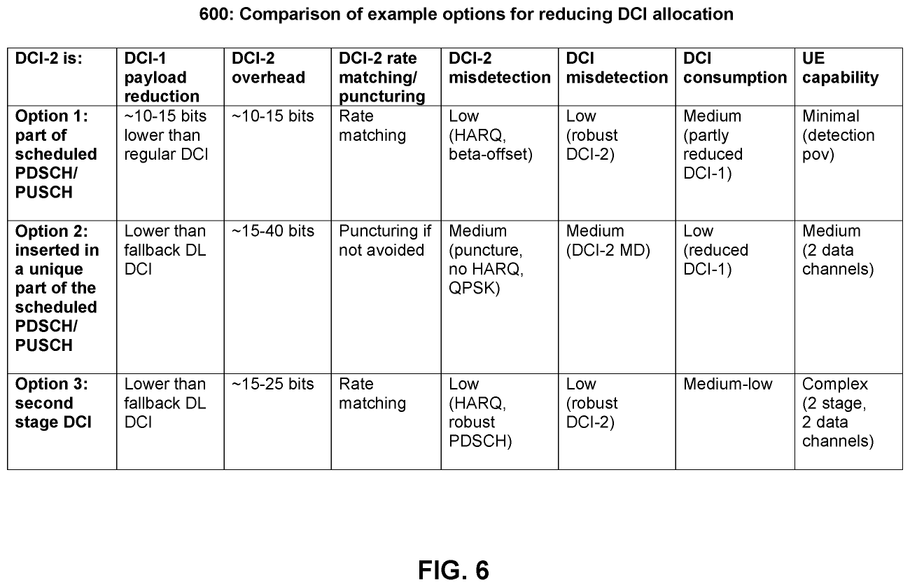

FIG. 6 is a diagram illustrating an example 600 of a comparison of example options for reducing DCI allocation, in accordance with the present disclosure.

As described above, the DCI may be split into a first portion of the DCI (shown as DCI-1) and a second portion of the DCI (shown as DCI-2). The first portion of the DCI may be blind decoded in the CORESET resources, such as in one or more CCE resources. In the first example (shown as option 1), the second portion of the DCI may be included as part of the scheduled PDSCH or PUSCH. In the second example (shown as option 2), the second portion of the DCI may be inserted in a unique part of the scheduled PDSCH or PUSCH. In the third example (shown as option 3), the second portion of the DCI may be second stage DCI that is received via a dedicated PDSCH. The base station 110 may select, and may configure the UE 120, with one or more of the various options based at least in part on one or more conditions of the scheduler, the link, and the capabilities of the UE 120. The example 600 illustrates some example characteristics of the first option, second option, and third option.

In the first option, the first portion of the DCI may have a payload that is approximately ten to fifteen bits lower than the regular DCI. The second portion of the DCI may be approximately ten to fifteen bits. The second portion of the DCI may include rate matching properties. The chances of a misdetection of the second portion of the DCI are low, for example, due to the available HARQ and beta offset. The low chances of the misdetection may be based at least in part on the robust second portion of the DCI. The DCI consumption may be medium, for example, due to the partly reduced first portion of the DCI. The capability requirements for the UE 120 may be minimal, from a detection standpoint.

In the second option, the first portion of the DCI may have a payload that is lower than the fallback downlink DCI. The second portion of the DCI may be approximately fifteen to forty bits. The second portion of the DCI may include puncturing. The chances of a misdetection of the second portion of the DCI are medium, for example, due to the puncturing, the lack of HARQ, and the QPSK. The DCI consumption may be low, for example, due to the reduced first portion of the DCI. The capability requirements for the UE 120 may be medium, for example, due to the two data channels that are required.

In the third option, the first portion of the DCI may have a payload that is lower than the fallback downlink DCI. The second portion of the DCI may be approximately fifteen to twenty-five bits. The second portion of the DCI may include rate matching properties. The chances of a misdetection of the second portion of the DCI are low, for example, due to the HARQ and the robust PDSCH. The low chances of the misdetection may be based at least in part on the robust second portion of the DCI. The DCI consumption may be medium-low. The capability requirements for the UE 120 may be complex, due to the two stage, two data channel procedure.

As indicated above, the example benefits and drawbacks of the various options shown in FIG. 6 are provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with DCI allocation reduction for massive MIMO based networks.

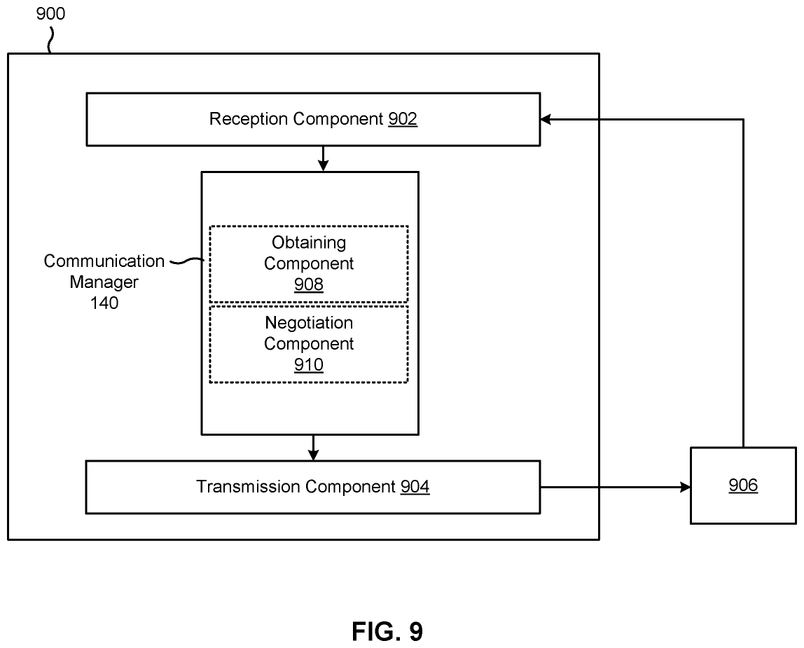

As shown in FIG. 7, in some aspects, process 700 may include receiving a first portion of DCI, via one or more control channel element resources, that includes information associated with a second portion of the DCI in a physical shared channel (block 710). For example, the UE (e.g., using communication manager 140 and/or reception component 902, depicted in FIG. 9) may receive a first portion of DCI, via one or more control channel element resources, that includes information associated with a second portion of the DCI in a physical shared channel, as described above.

As further shown in FIG. 7, in some aspects, process 700 may include obtaining the second portion of the DCI via the physical shared channel based at least in part on the information (block 720). For example, the UE (e.g., using communication manager 140 and/or obtaining component 908, depicted in FIG. 9) may obtain the second portion of the DCI via the physical shared channel based at least in part on the information, as described above.

Process 700 may include additional aspects, such as any single aspect or any combination of aspects described below and/or in connection with one or more other processes described elsewhere herein.

In a first aspect, the second portion of the DCI is integrated with other data in the physical shared channel.

In a second aspect, alone or in combination with the first aspect, the information associated with the second portion of the DCI is information for decoding the physical shared channel.

In a third aspect, alone or in combination with one or more of the first and second aspects, the information for decoding the physical shared channel includes allocation information, precoding information, rate matching information, MCS information, HARQ information, or beta offset information.

In a fourth aspect, alone or in combination with one or more of the first through third aspects, the second portion of the DCI is allocated using a first physical resource block of the physical shared channel.

In a fifth aspect, alone or in combination with one or more of the first through fourth aspects, the second portion of the DCI is included in a unique location of the physical shared channel.

In a sixth aspect, alone or in combination with one or more of the first through fifth aspects, the information associated with the second portion of the DCI is information for decoding the second portion of the DCI, and the second portion of the DCI includes information for decoding the physical shared channel.

In a seventh aspect, alone or in combination with one or more of the first through sixth aspects, the information for decoding the second portion of the DCI includes allocation information, physical resource block offset information for decoding the second portion of the DCI, or beta offset information, and the information for decoding the physical shared channel includes precoding information, rate matching information, MCS information, or HARQ information.

In an eighth aspect, alone or in combination with one or more of the first through seventh aspects, the unique location of the physical shared channel is a portion of the physical shared channel that is used only for the second portion of the DCI.

In a ninth aspect, alone or in combination with one or more of the first through eighth aspects, the second portion of the DCI is offset in a physical resource block of the physical shared channel.

In a tenth aspect, alone or in combination with one or more of the first through ninth aspects, the second portion of the DCI is second stage DCI that is included in a dedicated PDSCH.

In an eleventh aspect, alone or in combination with one or more of the first through tenth aspects, the information associated with the second portion of the DCI is information for decoding the second stage DCI in the dedicated PDSCH, and includes allocation information, precoding information, rate matching information, or HARQ information.

In a twelfth aspect, alone or in combination with one or more of the first through eleventh aspects, the second stage DCI includes information for decoding the physical shared channel.

In a thirteenth aspect, alone or in combination with one or more of the first through twelfth aspects, process 700 includes receiving, via an RRC message, information for performing blind detection for the first portion of the DCI.

In a fourteenth aspect, alone or in combination with one or more of the first through thirteenth aspects, the first portion of the DCI is blind decoded in the control channel element resources, and the physical shared channel is a scheduled PDSCH or a PUSCH.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with DCI allocation reduction for massive MIMO based networks.

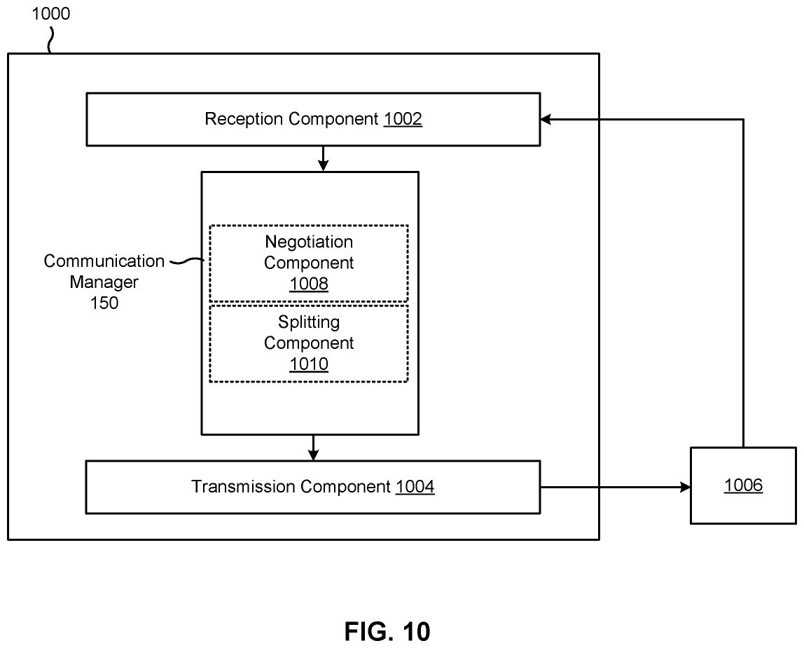

As shown in FIG. 8, in some aspects, process 800 may include transmitting a first portion of DCI, via one or more control channel element resources, that includes information associated with a second portion of the DCI in a physical shared channel (block 810). For example, the base station (e.g., using communication manager 150 and/or transmission component 1004, depicted in FIG. 10) may transmit a first portion of DCI, via one or more control channel element resources, that includes information associated with a second portion of the DCI in a physical shared channel, as described above.

As further shown in FIG. 8, in some aspects, process 800 may include transmitting the second portion of the DCI via the physical shared channel (block 820). For example, the base station (e.g., using communication manager 150 and/or transmission component 1004, depicted in FIG. 10) may transmit the second portion of the DCI via the physical shared channel, as described above.

Process 800 may include additional aspects, such as any single aspect or any combination of aspects described below and/or in connection with one or more other processes described elsewhere herein.

In a first aspect, the second portion of the DCI is integrated with other data in the physical shared channel.

In a second aspect, alone or in combination with the first aspect, the information associated with the second portion of the DCI is information for decoding the physical shared channel.

In a third aspect, alone or in combination with one or more of the first and second aspects, the information for decoding the physical shared channel includes allocation information, precoding information, rate matching information, MCS information, HARQ information, or beta offset information.

In a fourth aspect, alone or in combination with one or more of the first through third aspects, the second portion of the DCI is allocated using a first physical resource block of the physical shared channel.

In a fifth aspect, alone or in combination with one or more of the first through fourth aspects, the second portion of the DCI is included in a unique location of the physical shared channel.

In a sixth aspect, alone or in combination with one or more of the first through fifth aspects, the information associated with the second portion of the DCI is information for decoding the second portion of the DCI, and the second portion of the DCI includes information for decoding the physical shared channel.

In a seventh aspect, alone or in combination with one or more of the first through sixth aspects, the information for decoding the second portion of the DCI includes allocation information, physical resource block offset information for decoding the second portion of the DCI, or beta offset information, and the information for decoding the physical shared channel includes precoding information, rate matching information, MCS information, or HARQ information.

In an eighth aspect, alone or in combination with one or more of the first through seventh aspects, the unique location of the physical shared channel is a portion of the physical shared channel that is used only for the second portion of the DCI.

In a ninth aspect, alone or in combination with one or more of the first through eighth aspects, the second portion of the DCI is offset in a physical resource block of the physical shared channel.

In a tenth aspect, alone or in combination with one or more of the first through ninth aspects, the second portion of the DCI is second stage DCI that is included in a dedicated PDSCH.

In an eleventh aspect, alone or in combination with one or more of the first through tenth aspects, the information associated with the second portion of the DCI is information for decoding the second stage DCI in the dedicated PDSCH, and includes allocation information, precoding information, rate matching information, or HARQ information.

In a twelfth aspect, alone or in combination with one or more of the first through eleventh aspects, the second stage DCI includes information for decoding the physical shared channel.

In a thirteenth aspect, alone or in combination with one or more of the first through twelfth aspects, process 800 includes transmitting, via an RRC message, information for performing blind detection for the first portion of the DCI.

In a fourteenth aspect, alone or in combination with one or more of the first through thirteenth aspects, the first portion of the DCI is blind decoded in the control channel element resources, and the physical shared channel is a scheduled PDSCH or a PUSCH.

In a fifteenth aspect, alone or in combination with one or more of the first through fourteenth aspects, process 800 includes splitting the DCI into the first portion of the DCI and the second portion of the DCI.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of an obtaining component 908, or a negotiation component 910, among other examples.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a first portion of DCI, via one or more control channel element resources, that includes information associated with a second portion of the DCI in a physical shared channel. The obtaining component 908 may obtain the second portion of the DCI via the physical shared channel based at least in part on the information.

The negotiation component 910 may receive, via a RRC message, information for performing blind detection for the first portion of the DCI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more of a negotiation component 1008, or a splitting component 1010, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 may transmit a first portion of DCI, via one or more control channel element resources, that includes information associated with a second portion of the DCI in a physical shared channel. The transmission component 1004 may transmit the second portion of the DCI via the physical shared channel.

The negotiation component 1008 may transmit, via an RRC message, information for performing blind detection for the first portion of the DCI.

The splitting component 1010 may split the DCI into the first portion of the DCI and the second portion of the DCI.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a first portion of downlink control information (DCI), via one or more control channel element resources, that includes information associated with a second portion of the DCI in a physical shared channel; and obtaining the second portion of the DCI via the physical shared channel based at least in part on the information.

Aspect 2: The method of Aspect 1, wherein the second portion of the DCI is integrated with other data in the physical shared channel.

Aspect 3: The method of Aspect 2, wherein the information associated with the second portion of the DCI is information for decoding the physical shared channel.

Aspect 4: The method of Aspect 3, wherein the information for decoding the physical shared channel includes allocation information, precoding information, rate matching information, modulation and coding scheme (MCS) information, hybrid automatic repeat request (HARQ) information, or beta offset information.

Aspect 5: The method of Aspect 2, wherein the second portion of the DCI is allocated using a first physical resource block of the physical shared channel.

Aspect 6: The method of any of Aspects 1-5, wherein the second portion of the DCI is included in a unique location of the physical shared channel.

Aspect 7: The method of Aspect 6, wherein the information associated with the second portion of the DCI is information for decoding the second portion of the DCI, and the second portion of the DCI includes information for decoding the physical shared channel.

Aspect 8: The method of Aspect 7, wherein the information for decoding the second portion of the DCI includes allocation information, physical resource block offset information for decoding the second portion of the DCI, or beta offset information, and the information for decoding the physical shared channel includes precoding information, rate matching information, modulation and coding scheme (MCS) information, or hybrid automatic repeat request (HARQ) information.

Aspect 9: The method of Aspect 6, wherein the unique location of the physical shared channel is a portion of the physical shared channel that is used only for the second portion of the DCI.

Aspect 10: The method of Aspect 6, wherein the second portion of the DCI is offset in a physical resource block of the physical shared channel.

Aspect 11: The method of any of Aspects 1-10, wherein the second portion of the DCI is second stage DCI that is included in a dedicated physical downlink shared channel (PDSCH).

Aspect 12: The method of Aspect 11, wherein the information associated with the second portion of the DCI is information for decoding the second stage DCI in the dedicated PDSCH, and includes allocation information, precoding information, rate matching information, or hybrid automatic repeat request (HARQ) information.

Aspect 13: The method of Aspect 11, wherein the second stage DCI includes information for decoding the physical shared channel.

Aspect 14: The method of any of Aspects 1-13, further comprising receiving, via a radio resource control (RRC) message, information for performing blind detection for the first portion of the DCI.

Aspect 15: The method of any of Aspects 1-14, wherein the first portion of the DCI is blind decoded in the control channel element resources, and the physical shared channel is a scheduled physical downlink shared channel (PDSCH) or a physical uplink shared channel (PUSCH).

Aspect 16: A method of wireless communication performed by a base station, comprising: transmitting a first portion of downlink control information (DCI), via one or more control channel element resources, that includes information associated with a second portion of the DCI in a physical shared channel; and transmitting the second portion of the DCI via the physical shared channel.

Aspect 17: The method of Aspect 16, wherein the second portion of the DCI is integrated with other data in the physical shared channel.

Aspect 18: The method of Aspect 17, wherein the information associated with the second portion of the DCI is information for decoding the physical shared channel.

Aspect 19: The method of Aspect 18, wherein the information for decoding the physical shared channel includes allocation information, precoding information, rate matching information, modulation and coding scheme (MCS) information, hybrid automatic repeat request (HARQ) information, or beta offset information.

Aspect 20: The method of Aspect 17, wherein the second portion of the DCI is allocated using a first physical resource block of the physical shared channel.

Aspect 21: The method of any of Aspects 16-20, wherein the second portion of the DCI is included in a unique location of the physical shared channel.

Aspect 22: The method of Aspect 21, wherein the information associated with the second portion of the DCI is information for decoding the second portion of the DCI, and the second portion of the DCI includes information for decoding the physical shared channel.

Aspect 23: The method of Aspect 22, wherein the information for decoding the second portion of the DCI includes allocation information, physical resource block offset information for decoding the second portion of the DCI, or beta offset information, and the information for decoding the physical shared channel includes precoding information, rate matching information, modulation and coding scheme (MCS) information, or hybrid automatic repeat request (HARQ) information.

Aspect 24: The method of Aspect 21, wherein the unique location of the physical shared channel is a portion of the physical shared channel that is used only for the second portion of the DCI.

Aspect 25: The method of Aspect 21, wherein the second portion of the DCI is offset in a physical resource block of the physical shared channel.

Aspect 26: The method of any of Aspects 16-25, wherein the second portion of the DCI is second stage DCI that is included in a dedicated physical downlink shared channel (PDSCH).

Aspect 27: The method of Aspect 26, wherein the information associated with the second portion of the DCI is information for decoding the second stage DCI in the dedicated PDSCH, and includes allocation information, precoding information, rate matching information, or hybrid automatic repeat request (HARQ) information.

Aspect 28: The method of Aspect 26, wherein the second stage DCI includes information for decoding the physical shared channel.

Aspect 29: The method of any of Aspects 16-28, further comprising transmitting, via a radio resource control (RRC) message, information for performing blind detection for the first portion of the DCI.

Aspect 30: The method of any of Aspects 16-29, wherein the first portion of the DCI is blind decoded in the control channel element resources, and the physical shared channel is a scheduled physical downlink shared channel (PDSCH) or a physical uplink shared channel (PUSCH).

Aspect 31: The method of any of Aspects 16-30, further comprising splitting the DCI into the first portion of the DCI and the second portion of the DCI.

Aspect 32: An apparatus for wireless communication at a device, comprising a processor; memory coupled with the processor; and instructions stored in the memory and executable by the processor to cause the apparatus to perform the method of one or more of Aspects 1-15.

Aspect 33: A device for wireless communication, comprising a memory and one or more processors coupled to the memory, the one or more processors configured to perform the method of one or more of Aspects 1-15.

Aspect 34: An apparatus for wireless communication, comprising at least one means for performing the method of one or more of Aspects 1-15.

Aspect 35: A non-transitory computer-readable medium storing code for wireless communication, the code comprising instructions executable by a processor to perform the method of one or more of Aspects 1-15.

Aspect 36: A non-transitory computer-readable medium storing a set of instructions for wireless communication, the set of instructions comprising one or more instructions that, when executed by one or more processors of a device, cause the device to perform the method of one or more of Aspects 1-15.

Aspect 37: An apparatus for wireless communication at a device, comprising a processor; memory coupled with the processor; and instructions stored in the memory and executable by the processor to cause the apparatus to perform the method of one or more of Aspects 16-31.

Aspect 38: A device for wireless communication, comprising a memory and one or more processors coupled to the memory, the one or more processors configured to perform the method of one or more of Aspects 16-31.

Aspect 39: An apparatus for wireless communication, comprising at least one means for performing the method of one or more of Aspects 16-31.

Aspect 40: A non-transitory computer-readable medium storing code for wireless communication, the code comprising instructions executable by a processor to perform the method of one or more of Aspects 16-31.

Aspect 41: A non-transitory computer-readable medium storing a set of instructions for wireless communication, the set of instructions comprising one or more instructions that, when executed by one or more processors of a device, cause the device to perform the method of one or more of Aspects 16-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a first portion of downlink control information (DCI), via one or more control channel element resources, that includes information associated with a second portion of the DCI in a physical shared channel; and
obtain the second portion of the DCI via the physical shared channel based at least in part on the information.

2. The apparatus of claim 1, wherein the second portion of the DCI is integrated with other data in the physical shared channel.

3. The apparatus of claim 2, wherein the information associated with the second portion of the DCI is information for decoding the physical shared channel.

4. The apparatus of claim 3, wherein the information for decoding the physical shared channel includes allocation information, precoding information, rate matching information, modulation and coding scheme (MCS) information, hybrid automatic repeat request (HARQ) information, or beta offset information.

5. The apparatus of claim 1, wherein the second portion of the DCI is included in a unique location of the physical shared channel.

6. The apparatus of claim 5, wherein the information associated with the second portion of the DCI is information for decoding the second portion of the DCI, and the second portion of the DCI includes information for decoding the physical shared channel.

7. The apparatus of claim 6, wherein the information for decoding the second portion of the DCI includes allocation information, physical resource block offset information for decoding the second portion of the DCI, or beta offset information, and the information for decoding the physical shared channel includes precoding information, rate matching information, modulation and coding scheme (MCS) information, or hybrid automatic repeat request (HARQ) information.

8. The apparatus of claim 1, wherein the second portion of the DCI is second stage DCI that is included in a dedicated physical downlink shared channel (PDSCH).

9. The apparatus of claim 8, wherein the information associated with the second portion of the DCI is information for decoding the second stage DCI in the dedicated PDSCH, and includes allocation information, precoding information, rate matching information, or hybrid automatic repeat request (HARQ) information.

10. The apparatus of claim 8, wherein the second stage DCI includes information for decoding the physical shared channel.

11. An apparatus for wireless communication at a base station, comprising:
a memory; and
one or more processors, coupled to the memory, configured to:
transmit a first portion of downlink control information (DCI), via one or more control channel element resources, that includes information associated with a second portion of the DCI in a physical shared channel; and
transmit the second portion of the DCI via the physical shared channel.

12. The apparatus of claim 11, wherein the second portion of the DCI is integrated with other data in the physical shared channel.

13. The apparatus of claim 12, wherein the information associated with the second portion of the DCI is information for decoding the physical shared channel.

14. The apparatus of claim 13, wherein the information for decoding the physical shared channel includes allocation information, precoding information, rate matching information, modulation and coding scheme (MCS) information, hybrid automatic repeat request (HARQ) information, or beta offset information.

15. The apparatus of claim 11, wherein the second portion of the DCI is included in a unique location of the physical shared channel.

16. The apparatus of claim 15, wherein the information associated with the second portion of the DCI is information for decoding the second portion of the DCI, and the second portion of the DCI includes information for decoding the physical shared channel.

17. The apparatus of claim 16, wherein the information for decoding the second portion of the DCI includes allocation information, physical resource block offset information for decoding the second portion of the DCI, or beta offset information, and the information for decoding the physical shared channel includes precoding information, rate matching information, modulation and coding scheme (MCS) information, or hybrid automatic repeat request (HARQ) information.

18. The apparatus of claim 11, wherein the second portion of the DCI is second stage DCI that is included in a dedicated physical downlink shared channel (PDSCH).

19. The apparatus of claim 18, wherein the information associated with the second portion of the DCI is information for decoding the second stage DCI in the dedicated PDSCH, and includes allocation information, precoding information, rate matching information, or hybrid automatic repeat request (HARQ) information.

20. The apparatus of claim 18, wherein the second stage DCI includes information for decoding the physical shared channel.

21. A method of wireless communication performed by a user equipment (UE), comprising:
receiving a first portion of downlink control information (DCI), via one or more control channel element resources, that includes information associated with a second portion of the DCI in a physical shared channel; and
obtaining the second portion of the DCI via the physical shared channel based at least in part on the information.

22. The method of claim 21, wherein the second portion of the DCI is integrated with other data in the physical shared channel.

23. The method of claim 22, wherein the information associated with the second portion of the DCI is information for decoding the physical shared channel.

24. The method of claim 21, wherein the second portion of the DCI is included in a unique location of the physical shared channel.

25. The method of claim 21, wherein the second portion of the DCI is second stage DCI that is included in a dedicated physical downlink shared channel (PDSCH).

26. A method of wireless communication performed by a base station, comprising:
transmitting a first portion of downlink control information (DCI), via one or more control channel element resources, that includes information associated with a second portion of the DCI in a physical shared channel; and
transmitting the second portion of the DCI via the physical shared channel.

27. The method of claim 26, wherein the second portion of the DCI is integrated with other data in the physical shared channel.

28. The method of claim 27, wherein the information associated with the second portion of the DCI is information for decoding the physical shared channel.

29. The method of claim 26, wherein the second portion of the DCI is included in a unique location of the physical shared channel.

30. The method of claim 26, wherein the second portion of the DCI is second stage DCI that is included in a dedicated physical downlink shared channel (PDSCH).
